(19) United States
(12) Patent Application Publication
(10) Pub. No.: US 2011/0101559 A1
(43) Pub. Date: May 5, 2011

(54) METHOD OF MAKING A LAMP STAND OR CRAFTWORK

(76) Inventor: Qiu Hui Liao, Dongguan City (CN)

(21) Appl. No.: 11/746,182

(22) Filed: May 9, 2007

(51) Int. Cl. B28B 11/06

(52) U.S. Cl. 264/131; 264/299

(57) ABSTRACT

A method of making a lamp stand or other craftwork. The method begins by mixing materials with the following weight ratios: 1-10 kilograms of powdered Magnesia Usta; 1-10 kilograms of liquid magnesium chloride; 1-5 kilograms of glass quartz sand; 7-10 milliliters of activator; 5-50 milliliters of retarder; glass fiber and a paint for tinting. Next, the mixed materials are poured into a molded blowing die of the lamp stand and left within the die to solidify for approximately 3 to 5 hours. Next, the molded lamp stand is removed from the die. French chalk and de-foaming agent may be added to the mixed materials.

### BACKGROUND OF THE INVENTION

1. Field of the Invention

This invention relates to manufacturing. Specifically, and not by way of limitation, the present invention relates to a method of making a lamp stand or craftwork.

2. Description of the Related Art

Usually, a lamp stand or other craftwork is made from wood, metal or resin. However, the technical process of manufacturing the lamp stand or craftwork is quite complicated with using the above-mentioned materials. Some materials are quite light, therefore a balancing weight must be added into the lamp stand or craftwork. The product must then be decorated. Thus, the production costs for such products can be very high. It would be advantageous to have a method for manufacturing lamp stands or other craftworks which is cost-effective. It is an object of the present invention to provide such a method.

### SUMMARY OF THE INVENTION

The present invention provides a method of making a lamp stand or other craftwork. The method is simple and provides a low cost manufacturing process. The finished product is fireproof and does not require the addition of a balancing weight.

The method begins by mixing materials with the following weight ratios and ingredients: 1-10 kilograms of powdered Magnesia Usta; 1-10 kilograms of liquid magnesium chloride; 1-5 kilograms of glass quartz sand; 7-10 milliliters of activator; 5-50 milliliters of retarder; glass fiber and a paint for tinting. Next, the mixed materials are poured into a molded blowing die of the lamp stand and left within the die to solidify for approximately 3 to 5 hours. Next, the molded lamp stand is removed from the die. French chalk and de-foaming agent may be added to the mixed materials.

The present invention preferably utilizes the mixed materials with the following weight ratio: 2 kilograms of powdered Magnesia Usta; 2 kilograms of liquid magnesium chloride; 1 kilogram of glass quartz sand; 14 milliliters of activator and 10 milliliters of retarder.

The lamp stand made according to the present method may include a lamp seat, a lamp pole and an integrated lamp seat and pole.

The present invention provides a simple technical process, proper weight for the lamp stand or craftwork, and requires no balance weight because of the use of Magnesia Usta, liquid magnesium chloride, glass quartz sand, activator, retarder and glass fiber. If paint is utilized in the added materials, the lamp stand or craftwork may be constructed of a wide variety of colors. In addition, the finished product may also be coated with traditional paints.

### BRIEF DESCRIPTION OF THE DRAWINGS

FIG. 1 is a flow chart of the method of making a lamp stand or craftwork according to the teachings of the present invention; and

FIG. 2 is the side cross sectional view of a lamp stand.

### DESCRIPTION OF THE INVENTION

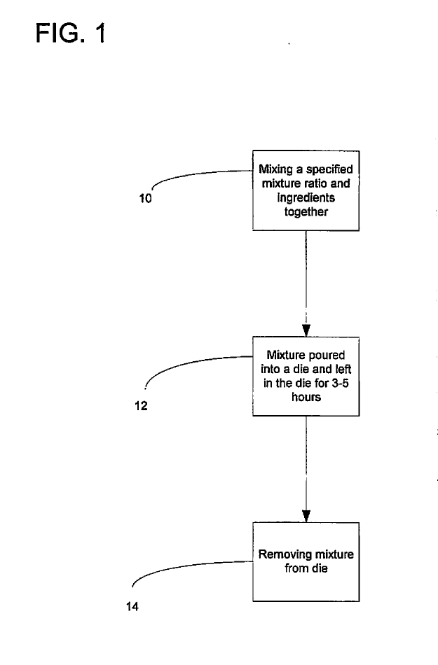

The present invention is a method of making a lamp stand or craftwork. FIG. 1 is a flow chart of the steps of making a lamp stand or craftwork affording to the teachings of the present invention. The method begins with step 10 where ingredients are mixed with the following weight ratios: 1-10 kilograms of powdered Magnesia Usta; 1-10 kilograms of liquid magnesium chloride; 1-5 kilograms of glass quartz sand; 7-70 milliliters of activator; 5-50 milliliters of retarder; glass fiber and a paint for reinforcing the intensity of the lamp stand. Glass fiber and paint may be added as desired by the manufacturer. Next, in step 12, the mixed materials are poured into a molded blowing die of the lamp stand and left within the die to solidify for approximately 3 to 5 hours. The method then moves to step 14 where the molded lamp stand is removed from the die. In addition, French chalk and de-foaming agent may be optionally added to the mixed materials to de-mould and remove air bubbles in the mixed material.

Although the present invention may utilize the above ratio ranges, in the preferred embodiment of the present invention, the following weight ratios of the above material may be utilized: 2 kilograms of powdered Magnesia Usta; 2 kilograms of liquid magnesium chloride; 1 kilogram of glass quartz sand; 14 milliliters of activator and 10 milliliters of retarder.

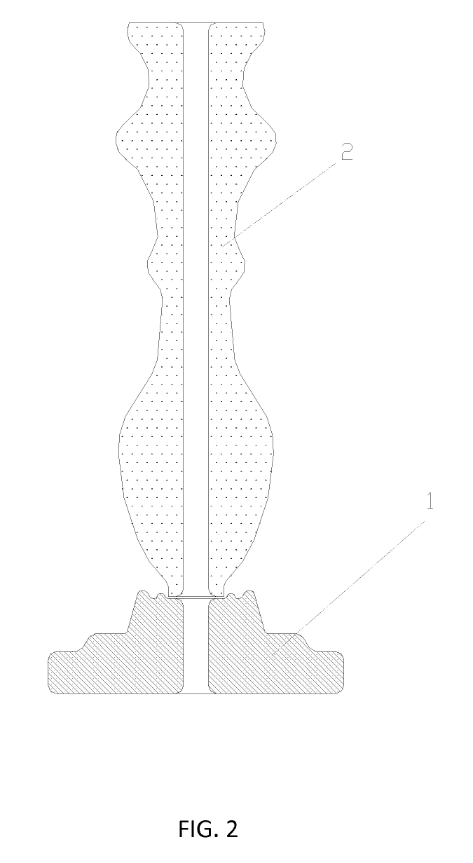

FIG. 2 is a side view of a lamp stand constructed using the method of FIG. 1. The lamp stand includes a lamp seat 1, a lamp pole 2 and an integrated lamp seat and pole. The external contour of the lamp stand or craftwork is made from a blowing process or a silicon and rubber die. The lamp stand is the finished product utilizing the present method.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A method of making a lamp stand or craftwork, the method comprising the steps of:
mixing a mixture having a ratio and ingredients of 1 to 10 kilograms of powered Magnesia Usta, 1 to 10 kilograms of liquid magnesium chloride, 1 to 5 kilograms of glass quart sand, 7 to 70 milliliters of activator, and 5 to 50 milliliters of retarder;
pouring the mixture into a molded blowing die for 3 to 5 hours, thereby solidifying the mixture;
removing the solidified mixture from the die to provided a molded finished product.

2. The method of making a lamp stand or craftwork of claim 1 wherein the step of mixing a mixture includes adding glass fiber and paint to the mixture.

3. The method of claim 1 wherein the die is a lamp stand.

4. The method of claim 1 wherein the die is a craftwork.

5. The method of claim 1 wherein the step of mixing the mixture includes adding a French chalk and defoaming agent to the mixture.

6. The method of claim 1 wherein said weight ratio of materials are as follows: approximately 2 kilograms of powdered Magnesia Usta, approximately 2 kilograms of liquid magnesium chloride, approximately 1 kilogram of glass quartz sand, approximately 14 milliliters of activator, and approximately 10 millimeters of retarder.

7. The method of claim 3 wherein the lamp stand includes a lamp seat, a lamp pole and an integrated lamp seat and pole.
